(19) United States
(12) Patent Application Publication
(10) Pub. No.: US 2015/0180065 A1
(43) Pub. Date: Jun. 25, 2015

(54) HYDROGEN PURGE UNIT FOR FUEL CELL SYSTEM

(71) Applicant: Hyundai Motor Company, Seoul (KR)

(72) Inventors: Bu Kil Kwon, Suwon (KR); Chi Myung Kim, Yongin (KR); Hyun Joon Lee, Yongin (KR)

(21) Appl. No.: 14/501,580

(22) Filed: Sep. 30, 2014

(30) Foreign Application Priority Data
Dec. 19, 2013 (KR) 10-2013-0159336

(51) Int. Cl. H01M 8/04

(52) U.S. Cl. CPC H01M 8/04231

(57) ABSTRACT

A fuel cell system having a hydrogen purge unit may include a purge pipe that connects an air discharge pipe connecting a fuel cell stack and a humidifying device and a hydrogen discharge pipe that discharges hydrogen from the fuel cell stack, and a purge valve provided at the purge pipe. In particular, a plurality of purge branch apertures are structured to discharge a purge gas from the fuel cell stack into the air discharge pipe by providing the purge branch apertures at intervals along the bottom surface of the purge pipe in a downstream section of the purge pipe that extends from the purge valve in a downstream direction.

### CROSS-REFERENCE TO RELATED APPLICATION

This application claims priority to and the benefit of Korean Patent Application No. 10-2013-0159336 filed in the Korean Intellectual Property Office on Dec. 19, 2013, the entire contents of which are incorporated herein by reference.

### BACKGROUND OF THE INVENTION

(a) Field of the Invention

An exemplary embodiment of the present invention relates to a fuel cell system, and more particularly, to a hydrogen purge unit for a fuel cell system that maintains a hydrogen concentration of a fuel electrode to be above a defined threshold.

(b) Description of the Related Art

A fuel cell system is a kind of a power generating system that supplies air and hydrogen to a fuel cell to generate electrical energy by an electrochemical reaction between hydrogen and oxygen by the fuel cell. Fuel cell systems may used to produce power for a fuel cell generating plant, a residential, a factory, or as a driving source for an electric motor in a vehicle, ship, train, or plane.

Typically, a fuel cell system includes a stack in which fuel cell units are stacked, a hydrogen supply unit that supplies hydrogen to fuel electrodes of the fuel cell units, and an air supply unit that supplies air to air electrodes of the fuel cell units. In order for an ion exchange membrane of a membrane-electrode assembly (MEA) to perform smoothly, a polymer fuel cell needs a moderate amount of moisture, and, thus, an effective fuel cell system typically also includes a humidifying device for humidifying a reactant gas supplied to the fuel cell stack.

This humidifying device humidifies air supplied from the air supply unit by putting moisture into a high temperature air as well as reusing humid air that is discharged from the air electrodes of the fuel cells. This humid air is then supplied to the air electrodes of the fuel cells. Additionally, fuel cell systems also typically include a hydrogen re-circulating unit that mixes hydrogen discharged from the fuel electrodes of the fuel cells with hydrogen supplied from the hydrogen supply unit to supply the mixture to the fuel electrodes.

However, impurities such as nitrogen and water vapor are accumulated to decrease a concentration of hydrogen in the fuel electrodes of the fuel cells during operation of the fuel cell system, and when the concentration of the hydrogen is excessively decreased, cell omission may occur in the fuel cell stack.

In order to solve this problem, in the fuel cell system, a purge valve is often provided on the hydrogen discharge side of the fuel cell stack, and by periodically opening the purge valve to discharge the impurities and the hydrogen, the hydrogen concentration of the fuel electrodes is maintained above a certain threshold.

Here, when the purge valve is opened to purge the fuel electrodes, the fuel electrodes discharge the impurities and the hydrogen, and the purge gas is introduced into the humidifying device together with the air discharged from the fuel cell stack. Thereafter, water vapor in the impurities is used as a humidifying source of the reactant gas required for the electrochemical reaction of the fuel cell in the humidifying device, and gases such as hydrogen and nitrogen are discharged into the atmosphere through an exhaust line of the humidifying device.

For example, in order to purge the hydrogen from the system, a dilution effect of purge hydrogen may be obtained by mixing hydrogen discharged from the fuel electrode with air discharged through the air discharge line from the fuel cell stack.

However, this process partially reduces the concentration of the hydrogen by mixing air with hydrogen due to the purge hydrogen being discharged into the air discharge line of the fuel cell stack. Since the mixing effect of the hydrogen and the air is not sufficiently implemented, it is difficult to effectively reduce the concentration of the hydrogen.

Particularly, when the purge valve is opened, since a considerable amount of hydrogen is instantaneously discharged within a very short time (generally, within one second), the concentration of the hydrogen discharged into the atmosphere is very high. Accordingly, when a flame source is presented in a concentration range of 4 to 75%, an explosion may occur.

In order to prevent such an explosion, when the hydrogen purge is being operated, the fuel cell system needs to adopt a method for discharging hydrogen discharged from the fuel electrode into the atmosphere at a concentration below a certain threshold. Currently, there is no such method.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a hydrogen purge unit of a fuel cell system which reduces a concentration of hydrogen discharged into the atmosphere by improving a structure in which purge hydrogen is discharged into an air discharge line of a fuel cell stack.

An exemplary embodiment of the present invention provides a hydrogen purge unit of a fuel cell system including a purge pipe that connects an air discharge pipe for connecting a fuel cell stack and a humidifying device and a hydrogen discharge pipe for discharging hydrogen from the fuel cell stack, and a purge valve provided at the purge pipe. Additionally, a plurality of purge branch apertures for discharging a purge gas discharged from the fuel cell stack into the air discharge pipe may be formed at intervals in a downstream section of the purge pipe from the purge valve.

Further, in the hydrogen purge unit of a fuel cell system according to the exemplary embodiment of the present invention, connection apertures that are connected to the purge branch apertures may be formed in the air discharge pipe.

Furthermore, in the hydrogen purge unit of a fuel cell system according to the exemplary embodiment of the present invention, the downstream section of the purge pipe extending from the purge valve may be integrally bonded to an outer surface of the air discharge pipe. More specifically in some exemplary embodiment of the present invention, the downstream section of the purge pipe extending from the purge valve may be integrally bonded to an upper side of an outer surface of the air discharge pipe. In addition, in the hydrogen purge unit of a fuel cell system according to the exemplary embodiment of the present invention, an end of the purge pipe may be closed.

Further, in the hydrogen purge unit of a fuel cell system according to the exemplary embodiment of the present invention, the purge branch apertures may be formed in the purge pipe in intervals separated from each other by a predetermined distance or alternatively at variable distances in a flow direction of the purge gas.

In addition, in the hydrogen purge unit of a fuel cell system according to the exemplary embodiment of the present invention, the purge branch apertures may be formed at intervals so that they are separated from each other in a flow direction of the purge gas such that distances between each of the purge branch apertures is gradually decreased as the purge branch apertures are positioned closer to an end of the purge pipe and are farther apart closer to an inlet of the purge pipe (i.e., an inflow end thereof).

Another embodiment of the present invention provides a hydrogen purge unit of a fuel cell system including a purge pipe that connects an air discharge pipe for connecting a fuel cell stack and a humidifying device and a hydrogen discharge pipe for discharging hydrogen from the fuel cell stack, and a purge valve provided at the purge pipe. A downstream section of the purge pipe from the purge valve may be positioned within the air discharge pipe, and a plurality of purge branch apertures discharging a purge gas discharged from the fuel cell stack into the air discharge pipe may be formed at intervals in the purge pipe.

Furthermore, in the hydrogen purge unit of a fuel cell system according to another exemplary embodiment of the present invention, the air discharge pipe and the purge pipe may be configured to have a double pipe structure.

Moreover, in the hydrogen purge unit of a fuel cell system according to the another exemplary embodiment of the present invention, the downstream section of the purge valve from the purge valve may serve as a flowing path for flowing the purge gas in the same direction as a flow direction of air flowing in the air discharge pipe.

Further, in the hydrogen purge unit of a fuel cell system according to the another exemplary embodiment of the present invention, the downstream section of the purge pipe from the purge valve may be disposed within a flow-path at an upper end of the air discharge pipe within the air discharge pipe, and in some exemplary embodiments the downstream section of the purge pipe extending from the purge valve may be integrally bonded to the air discharge pipe.

Further, in the hydrogen purge unit of a fuel cell system according to the another exemplary embodiment of the present invention, an end of the purge pipe may be an outlet end of the purge gas and may be connected to the inside of the air discharge pipe. As such, in some embodiments, the purge branch apertures may be formed within a flow-path along the lower surface of the purge pipe.

In addition, in the hydrogen purge unit of a fuel cell system according to the another exemplary embodiment of the present invention, the purge branch apertures may be formed in the purge pipe to be separated from each other with a predetermined distance in a flow direction of the purge gas.

Moreover, in the hydrogen purge unit of a fuel cell system according to another exemplary embodiment of the present invention, the purge branch apertures may be formed in the purge pipe at intervals separated from each other at variable distances in a flow direction of the purge gas.

However again, in the hydrogen purge unit of a fuel cell system according to the another exemplary embodiment of the present invention, the purge branch apertures may be formed to be separated from each other in a flow direction of the purge gas such that distances between the purge branch apertures are gradually increased as the purge branch apertures are positioned closer to an inlet end of the purge pipe from the outlet end thereof.

According to exemplary embodiments of the present invention, since a concentration of hydrogen exhausted into the atmosphere by forming the purge branch apertures for discharging the purge gas into the air discharge pipe at the purge pipe and adjusting how far apart each of these apertures are from each other, it is possible to effectively dilute the concentration of the purge hydrogen without consuming additional power.

### BRIEF DESCRIPTION OF THE DRAWINGS

These drawings are presented to describe exemplary embodiments of the present invention, and, thus, the technical spirit of the present invention should not be interpreted as being limited to the accompanying drawings.

FIG. 1 is a schematic block diagram illustrating an example of a fuel cell system to which an exemplary embodiment of the present invention is applied.

FIGS. 2 and 3 are schematic cross-sectional views illustrating a hydrogen purge unit of a fuel cell system according to an exemplary embodiment of the present invention.

FIG. 4 is a table illustrating a relation between a flow rate and a flow velocity for describing an operational effect of the hydrogen purge unit of a fuel cell system according to the exemplary embodiment of the present invention.

FIG. 5 is a schematic cross-sectional view illustrating a hydrogen purge unit of a fuel cell system according to another exemplary embodiment of the present invention.

FIG. 6 is a schematic cross-sectional view illustrating a hydrogen purge unit of a fuel cell system according to yet another exemplary embodiment of the present invention.

FIG. 7 is a cross-sectional view illustrating a modification of purge branch apertures applied to the hydrogen purge unit of a fuel cell system according to the yet another exemplary embodiment of the present invention.

### DETAILED DESCRIPTION OF THE EMBODIMENTS

The present invention will be described more fully hereinafter with reference to the accompanying drawings, in which exemplary embodiments of the invention are illustrated. As those skilled in the art would realize, the described embodiments may be modified in various different ways, all without departing from the spirit or scope of the present invention.

Unrelated parts will be omitted to clearly describe the present invention, and throughout the specification, the same or similar constituent elements will be assigned the same reference numeral.

In the drawings, sizes and thicknesses of components are arbitrarily illustrated for the convenience in description, and, thus, the present invention is not necessarily limited to the drawings. The thicknesses thereof are thickly illustrated to clarify various portions and regions.

Further, in the following detailed description, the terms ‘first,’ ‘second,’ and the like, given to components having the same configuration are only used to distinguish one component from another, and the terms do not necessarily denote any order in the following detailed description.

Throughout the specification, unless explicitly described to the contrary, the word “comprise” and variations such as “comprises” or “comprising,” will be understood to imply the inclusion of stated elements but not the exclusion of any other elements.

Furthermore, the terms “ . . . unit,” “ . . . means,” “ . . . part,” “member,” and the like, described in the specification means a unit having a comprehensive configuration so as to perform at least one function or operation.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

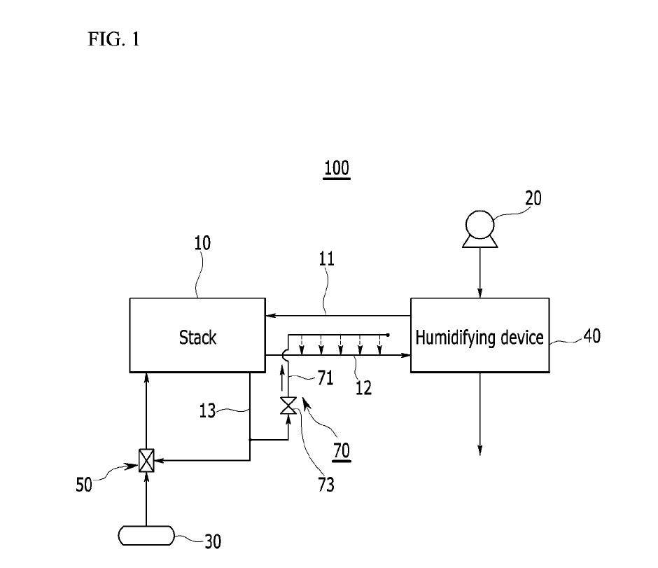

FIG. 1 is a schematic block diagram illustrating an example of a fuel cell system to which an exemplary embodiment of the present invention is applied. Referring to FIG. 1, a fuel cell system 100 to which an exemplary embodiment of the present invention is applied is a power generating system that produces electric energy by an electrochemical reaction between an oxidizing agent and fuel, and may be provided within, for example, a fuel cell vehicle that utilizes an electric motor to drive the vehicle and thus requires an electrical energy source. In the exemplary embodiment of the present invention, the fuel used in the fuel cell system 100 may be described in terms of a hydrogen gas (hereinafter, referred to as “hydrogen” for the sake of convenience), and the oxidizing agent may be described as air. However, the fuel and oxidizing agent are not necessarily limited thereto and thus can include any alternative fuel or oxidizing agent known for use in the fuel cell without departing from the overall concept of the present invention.

As such, the fuel cell system 100 includes a fuel cell stack 10, an air supply unit 20, a hydrogen supply unit 30, a humidifying device 40, and a hydrogen re-circulating unit 50. In particular, fuel cell stack 10 may be embodied as an electricity generating assembly made up of a plurality of fuel cell units that each include air electrodes and fuel electrodes. The fuel cell stack 10 receives hydrogen supplied from the hydrogen supply unit 30 and receives air from the air supply unit 20 in order to be able to generate electrical energy via an electrochemical reaction between hydrogen and oxygen.

The air supply unit 20 may be embodied as an air compressor or an air blower that is driven by receiving power thereto and is structured to provide air from the atmosphere to the air electrode of the fuel cell stack 10. The hydrogen supply unit 30 may include a hydrogen tank that compresses hydrogen into a gas phase, stores the compressed hydrogen, and supplies the stored hydrogen to the fuel electrode of the fuel cell stack 10 upon demand.

Additionally, the humidifying device 40 in FIG. 1 may include a membrane humidifying device that membrane-humidifies the air supplied from the air supply unit 20 by using air discharged from the air electrode of the fuel cell stack 10. The humidifying device 40 may be connected to the fuel cell stack 10 through an air supply pipe 11 and an air discharge pipe 12.

The hydrogen re-circulating unit 50 may be provided to re-circulate hydrogen discharged from the fuel electrode of the fuel cell stack 10 into the fuel electrode, and may mix hydrogen discharged through the hydrogen discharge pipe 13 from the fuel cell stack 10 with the hydrogen supplied from the hydrogen supply unit 30 by an ejector to be able to supply the mixture to the fuel electrode of the fuel cell stack 10.

A hydrogen purge unit 70 according to an exemplary embodiment of the present invention applied to the above-described fuel cell system 100 is configured to manage a concentration of the hydrogen of the fuel electrode to be above a threshold value by discharging impurities together with hydrogen from the fuel electrode when impurities such as nitrogen and water vapor are accumulated in the fuel electrode of the fuel cell during the operation of the fuel cell system 100 and thereby the hydrogen concentration is decreased.

For example, the hydrogen purge unit 70 according to the exemplary embodiment of the present invention may adopt a hydrogen purge method which the hydrogen and impurities (hereinafter, referred to as a “purge gas” for the sake of convenience) discharged from the fuel electrode are mixed with air discharged through the air discharge pipe 12 from the fuel cell stack 10 to be able to obtain a hydrogen diluting effect on the purge gas.

The hydrogen purge unit 70 of the fuel cell system according to the exemplary embodiment of the present invention that adopts the hydrogen purge method includes a purge pipe 71 that connects the air discharge pipe 12 and the hydrogen discharge pipe 13 described above, and a purge valve 73 provided within the purge pipe 71 along the flow path.

The purge pipe 71 may be any pipe having a predetermined inner diameter, and the purge valve 73 may be any valve that can selectively open or close a flow-path of the purge pipe 71 in response to a control signal from a controller (not illustrated in the drawing).

The hydrogen purge unit 70 of the fuel cell system according to the exemplary embodiment of the present invention has a structure that reduces the concentration of the hydrogen discharged into the atmosphere through the humidifying device 40 by changing the purge pipe 71 through which the purge gas is discharged into the air discharge pipe 12 of the fuel cell stack 10.

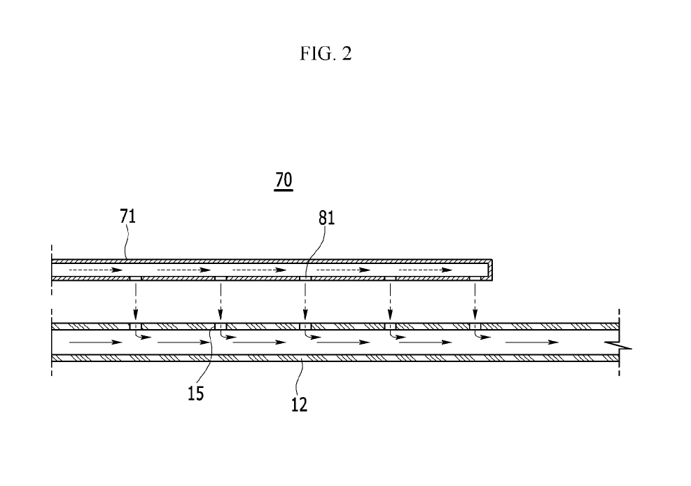

FIG. 2 is a schematic cross-sectional view illustrating a connection structure of the purge pipe applied to the hydrogen purge unit of the fuel cell system according to the exemplary embodiment of the present invention. Referring to FIG. 2, the hydrogen purge unit 70 of the fuel cell system according to the exemplary embodiment of the present invention may be provided with the purge pipe 71 in which a plurality of purge branch apertures 81 for discharging the purge gas discharged from the fuel cell stack 10 into the air discharge pipe 12 is divisionally formed in the purge pipe 71 downstream from the purge valve 73.

That is, the purge branch apertures 81 for discharging the purge gas into the air discharge pipe 12 are formed in the downstream section of the purge pipe 71 from the purge valve 73 along a flow path of the purge gas. Here, in order to discharge the purge gas into the air discharge pipe 12 through the purge branch apertures 81, connection apertures 15 connected to the purge branch apertures 81 are formed in the air discharge pipe 12.

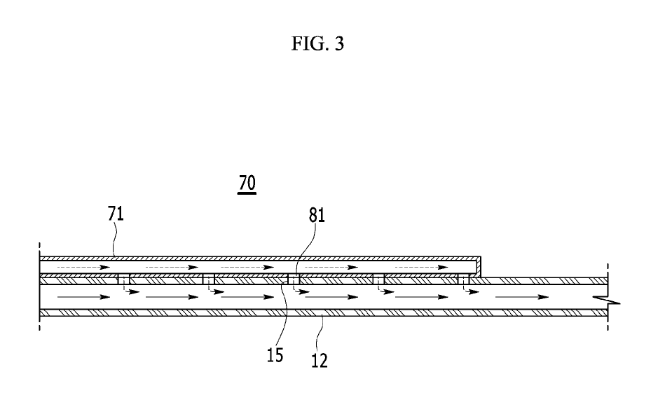

At this time, the purge branch apertures 81 are formed long the bottom surface of the purge pipe 71, and the connection apertures 15 corresponding to the purge branch apertures 81 are formed on the top surface of the air discharge pipe 12. In the exemplary embodiment of the present invention, the downstream section of the purge pipe 71 from the purge valve 73 may be integrally bonded to an outer top surface of the air discharge pipe 12, as illustrated in FIG. 3.

In this case, the purge branch apertures 81 of the purge pipe 71 are connected to the connection apertures 15 of the air discharge pipe 12. Further, an end of the purge pipe 71, that is, an end of the downstream section thereof from the purge valve 73 corresponding to an inlet end of the purge pipe 71 is not opened but is instead closed.

The downstream section of the purge pipe 71 from the purge valve 73 may be integrally bonded to an upper end of the outer surface of the air discharge pipe 12. The downstream section of the purge pipe 71 from the purge valve 73 may be bonded to the top outer surface of the air discharge pipe 12 via a weld.

Meanwhile, in the exemplary embodiment of the present invention, the purge branch apertures 81 formed in the downstream section of the purge pipe 71 from the purge valve 73 may be arranged in intervals so that the purge branch apertures 81 are separated from each other with a certain distance in a flow direction of the purge gas.

For example, a length of the air discharge pipe 12 is 5 m, and a flow rate of the air flowing along the air discharge pipe 12 is 400 Normal Liters Per Minute (NLPM). When a total flow rate of the purge hydrogen flowing along the purge pipe 71 is 113 NLPM, the purge branch apertures 81 are formed at the downstream section of the purge pipe 71 from the purge valve with a distance of 1 m, and can discharge the purge gas into the air discharge pipe 12 by 23 NLPM.

In this case, when a purge hydrogen amount of 113 NLPM is discharged through one purge branch hole 81, the hydrogen concentration of the purge gas is up to 22%. However, when five purge branch apertures 81 are arranged with a certain distance and the purge gas is discharged through the purge branch apertures 81, the hydrogen concentration of the purge gas can be reduced by up to 5.4%.

In the exemplary embodiment of the present invention, although it has been described that the purge branch apertures 81 formed in the downstream section of the purge pipe 71 from the purge valve 73 are arranged in intervals so that they are separated from each other with a certain distance in the flow direction of the purge gas, the present invention is not necessarily limited thereto. For example, thee purge branch apertures 81 may be also formed at the purge pipe 71 in intervals so that they are separated from each other at variable distances in the flow direction of the purge gas depending on the flow rate of the purge gas and the flow rate of the discharged air.

In addition, it has been described in the exemplary embodiment of the present invention that the downstream section of the purge pipe 71 from the purge valve 73 may be integrally bonded to the upper end of the outer surface of the air discharge pipe 12 and the purge branch apertures 81 of the purge pipe 71 are connected to the connection apertures 15 of the air discharge pipe 12.

However, the present invention is not limited to the aforementioned description, the downstream section of the purge pipe 71 extending from the purge valve 73 may be disposed to be separated from the top outer surface of the air discharge pipe 12 by a certain distance, and the purge branch apertures 81 of the purge pipe 71 may be connected to the connection apertures 15 of the air discharge pipe 12 through a connecting pipe.

Next, an operation of the hydrogen purge unit 70 of the fuel cell system according to the exemplary embodiment of the present invention having the aforementioned configuration will be described in detail with reference to the drawings described above.

First, in the exemplary embodiment of the present invention, during the operation of the fuel cell system 100, the air is supplied to the fuel cell stack 10 through the air supply unit 20, and the hydrogen is supplied to the fuel cell stack 10 through the hydrogen supply unit 30. Thereafter, the fuel cell stack 10 generates electrical energy by an electrochemical reaction between hydrogen and oxygen by the fuel cells, discharges air of high temperature and humidity from the air electrodes of the fuel cells through the air discharge pipe 12, and discharges moisture-containing hydrogen through the hydrogen discharge pipe 13 from the fuel electrodes of the fuel cells.

Here, the fuel electrodes of the fuel cells discharge the hydrogen remaining after the reaction and the hydrogen may be then be re-circulated together with the hydrogen supplied from the hydrogen supply unit 30 through the hydrogen re-circulating unit 50 to the fuel electrodes.

In this process, air discharged from the air electrodes of the fuel cells may be supplied to the humidifying device 40 through the air discharge pipe 12, and the humidifying device 40 may air supplied from the air supply unit 20 by using the discharge air. This humidified air is then supplied to the air electrodes of the fuel cells.

On the other hand, in the exemplary embodiment of the present invention, during the operation of the fuel cell system 100, when impurities such as nitrogen and water vapor are accumulated in the fuel electrode of the fuel cell to decrease the concentration of the hydrogen, the purge valve 73 is opened to perform a hydrogen purge that discharges the purge gas from the fuel electrodes through the purge pipe 71.

Subsequently, the purge gas flows through purge pipe 71, and is introduced into the air discharge pipe 12 through the apertures 81. That is, in the exemplary embodiment of the present invention, the purge gas may be discharged into the air discharge pipe 12 through the purge branch apertures 81 in the downstream section of the purge pipe 71 from the purge valve 73.

Here, since the purge branch apertures 81 are formed in the downstream section of the purge pipe 71 from the purge valve 73 at a certain distance, in the exemplary embodiment of the present invention, the purge gas flowing along the purge pipe 71 may be discharged into the air discharge pipe 12 by being appropriately distributed through the purge branch apertures 81.

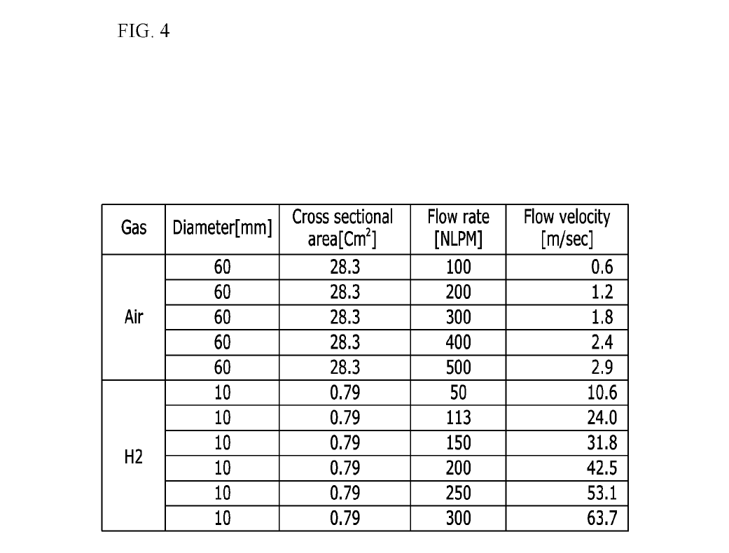

For example, in general, the air discharge pipe 12 having an inner diameter of about 50 to 70 mm and the purge pipe 71 having an inner diameter of about 6 to 12 mm are mostly used. In the exemplary embodiment of the present invention, when the inner diameter of the air discharge pipe 12 is 60 mm and the inner diameter of the purge pipe 71 is 10 mm, flow velocities according to flow rates of the pipes 12 and 71 are represented in Table of FIG. 4.

As illustrated in FIG. 4, in the exemplary embodiment of the present invention, it can be seen that when a flow rate of the air flowing along the air discharge pipe 12 is 400 NLPM and a total flow rate of the hydrogen flowing along the purge pipe 71 is 113 NLPM, a flow velocity of the hydrogen during the hydrogen purge is 10 times greater than a flow velocity of the air.

Accordingly, in the exemplary embodiment of the present invention, when a hydrogen purge is performed through the purge branch apertures 81 divisionally formed in the downstream section of the purge pipe 71 extending from the purge valve 73 along a certain distance thereof by using an increased flow velocity of the purge gas, it is possible to maximize a dilution effect on the hydrogen concentration.

More specifically, when the length of the air discharge pipe 12 is about 5 m, the flow rate of the air flowing along the air discharge pipe 12 is 400 NLPM and the total flow rate of the purge hydrogen flowing along the purge pipe 71 is 113 NLPM, a time for which the air passes through the air discharge pipe 12 is about 2.1 seconds, whereas a time for which the hydrogen passes the same distance is 0.21 seconds.

As described above, in the exemplary embodiment of the present invention, by discharging the purge gas into the air discharge pipe 12 at a high flow velocity through the purge branch apertures 81 formed in the purge pipe 71, it is possible to dilute the concentration of the hydrogen by the air within the air discharge pipe 12 to the utmost.

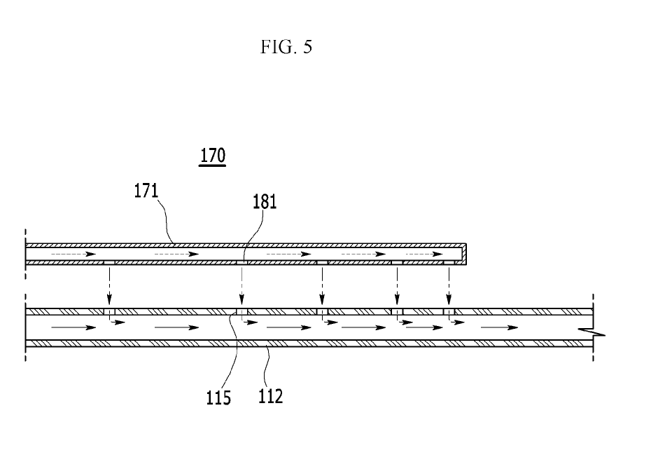

FIG. 5 is a schematic cross-sectional view illustrating a hydrogen purge unit of a fuel cell system according to another exemplary embodiment of the present invention. In the drawing, the same constituent elements as those in the aforementioned exemplary embodiment will be assigned the same reference numerals as those in the aforementioned exemplary embodiment.

Referring to FIG. 5, a hydrogen purge unit 170 of a fuel cell system according to an exemplary embodiment of the present invention has a structure of the aforementioned exemplary embodiment, and may include purge branch apertures 181 such that distances between the purge branch apertures are gradually decreased as they are positioned closer to an end of the purge pipe 171 from an inlet end thereof and the purge branch apertures are separately formed at intervals from each other in the flow direction of the purge gas.

That is, the purge branch apertures 181 may be formed such that distances between the purge branch apertures gradually decreased as they are positioned closer to an outlet of an air discharge pipe 112 from an inlet thereof. Here, connection apertures 115 that are formed in the air discharge pipe 112 and connected to the purge branch apertures 181 may be arranged such that distances between the connection apertures are gradually decreased as they are positioned closer to the end of the air discharge pipe 112 from the inlet end thereof.

Accordingly, in the exemplary embodiment of the present invention, when the length of the air discharge pipe 112 is about 5 m, the flow rate of the air flowing along the air discharge pipe 112 is 400 NLPM and the total flow rate of the purge hydrogen flowing along the purge pipe 171 is 113 NLPM, it is possible to perform the purge while changing the discharge intervals of the purge gas from the purge branch apertures 181.

Accordingly, in the exemplary embodiment of the present invention, since the purge branch apertures 181 are formed so that distances between the purge branch apertures are gradually decreased as they are positioned closer to the outlet of the air discharge pipe 112 from the inlet thereof, the hydrogen is partially mixed with the air while the purge gas passes through the air discharge pipe 112. Accordingly, it is possible to further reduce the concentration of the hydrogen finally exhausted by adjusting gaps between the purge branch apertures 181.

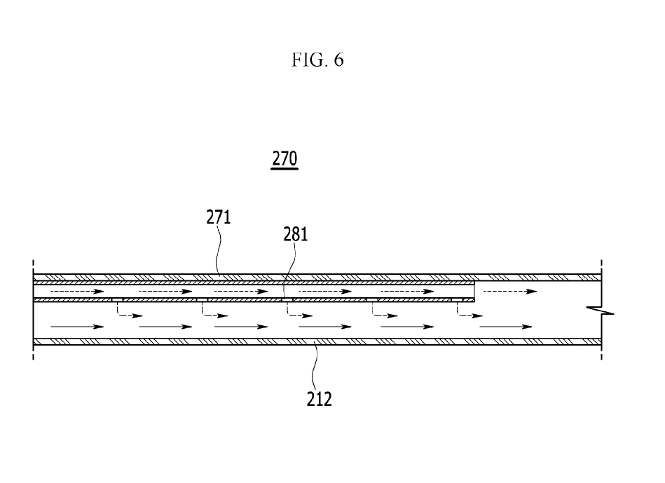

FIG. 6 is a schematic cross-sectional view illustrating a hydrogen purge unit of a fuel cell system according to yet another exemplary embodiment of the present invention. Referring to FIG. 6, a hydrogen purge unit 270 of a fuel cell system according to yet another exemplary embodiment of the present invention may include a purge pipe 271 in which a downstream section thereof from the purge valve is positioned inside an air discharge pipe 212 and a plurality of branch apertures 281 for discharging the purge gas discharged from the fuel electrode into the air discharge pipe 212 are separately formed along the bottom surface of the purge pipe 271.

In the exemplary embodiment of the present invention, the downstream section of the purge pipe 271 from the purge valve may serve as a flow path for the purge gas in the same direction as the flow direction of the air flowing in the air discharge pipe 212, and may be disposed inside the air discharge pipe 212. That is, the purge pipe 271 of the air discharge pipe 212 may have a double pipe structure (i.e., a pipe within a pipe).

Here, the downstream section of the purge pipe 271 from the purge valve may be disposed at a flow-path upper end of the air discharge pipe 212 within the air discharge pipe 212, and may be integrally bonded to an inner surface of the air discharge pipe 212 through welding weld, for example.

In this case, an end of the purge pipe 271 has an outlet at an open end of the pipe for discharging the purge gas therethrough into the air discharge pipe 212, and is connected to the inside of the air discharge pipe 212, and the purge branch apertures 281 of the purge pipe 271 may be formed in a bottom surface of the purge pipe 271. Furthermore, the purge branch apertures 281 may be formed in the purge pipe 271 separately from each other at a certain distance apart in a flow direction of the purge gas (i.e. intervally). In particular, the reason why an open ended outlet is formed in this embodiment is because moisture in the purge gas flowing along the purge pipe 271 is prevented from being frozen in winter. Moreover, the reason why the downstream section of the purge pipe 271 from the purge valve is disposed at the upper end of the flow-path within the air discharge pipe 212 is because moisture in the air flowing along the air discharge pipe 212 is prevents corrosion in the purge pipe 271.

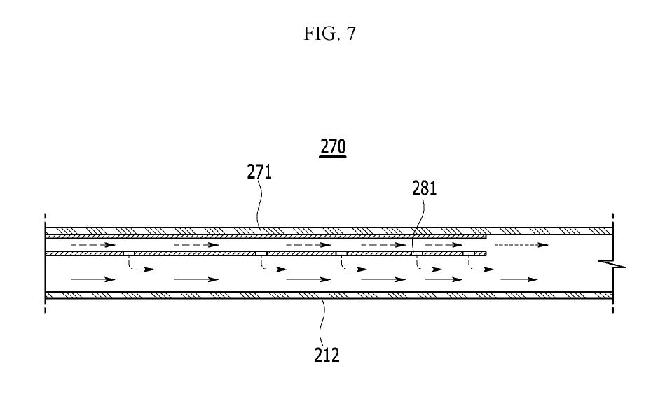

Alternatively, as illustrated in FIG. 7, the purge branch apertures 281 may be formed at the purge pipe 271 in the flow direction of the purge gas at intervals in order to be separated from each other such that distances between the purge branch apertures are gradually increased as they are positioned closer to the inlet end of the purge pipe 271 from the outflow end thereof.

Meanwhile, cross sectional areas of the purge branch apertures 281 according to the yet another exemplary embodiment of the present invention may be adjusted depending on specifications and volume of the fuel cell system.

For example, in the exemplary embodiment of the present invention, when a flow-path inner diameter of the purge pipe 271 is about 10 mm, if an instantaneous flow rate of the purge gas through purge pipe 271 is significant, an inner diameter of the purge branch hole 281 may be set to about 5±1 mm, and if an instantaneous flow rate of the purge gas through the purge pipe 271 is low, the inner diameter of the purge branch hole 281 may be set to about 3±1 mm.

Other configurations and operational effects of the hydrogen purge unit 270 of the fuel cell system according to the yet another exemplary embodiment of the present invention are the same as those in the aforementioned exemplary embodiments, and, thus, the descriptions thereof will not be presented.

On the other hand, in the hydrogen purge units 70, 170 and 270 of the fuel cell system according to the exemplary embodiments of the present invention described above, the amount of hydrogen exhausted during the purge can be adjusted depending on the flow rate (flow velocity) of the discharge air to be able to perform the purge. That is, in the exemplary embodiments of the present invention, the flow velocity of the air and the flow velocity of the purged hydrogen are calculated to adjust a purge interval, so that it is possible to adjust the concentration of the exhausted hydrogen so as not to exceed a target set value.

Accordingly, in the exemplary embodiments of the present invention, it is possible to effectively dilute the hydrogen concentration of the purge hydrogen without additionally consuming a power, and it is possible to control the concentration of the exhausted hydrogen by using known information regarding vehicle output, for example, the flow rate/flow velocity of the air and the concentration/flow rate/flow velocity of the purged hydrogen.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10 . . . Fuel cell stack
11 . . . Air supply pipe
12, 112, 212 . . . Air discharge pipe
13 . . . Hydrogen discharge pipe
15 . . . Connection hole
20 . . . Air supply unit
30 . . . Hydrogen supply unit
40 . . . Humidifying device
50 . . . Hydrogen re-circulating unit
70, 170, 270 . . . Hydrogen purge unit
71, 171, 271 . . . Purge pipe
73, 273 . . . Purge valve
81, 181, 281 . . . Purge branch hole
100 . . . Fuel cell system

What is claimed is:

1. A hydrogen purge unit of a fuel cell system including:
a purge pipe connecting an air discharge pipe that connects a fuel cell stack and a humidifying device and a hydrogen discharge pipe that contains hydrogen that is discharged from the fuel cell stack; and
a purge valve provided at the purge pipe,
wherein the purge pipe includes a plurality of purge branch apertures that discharge a purge gas discharged from the fuel cell stack into the air discharge pipe, the purge branch apertures are formed separately along a downstream section of the purge pipe that extends from the purge valve.

2. The hydrogen purge unit of a fuel cell system of claim 1, wherein:
connection apertures are formed in the air discharge pipe, and are connected to the purge branch apertures.

3. The hydrogen purge unit of a fuel cell system of claim 2, wherein:
the downstream section of the purge pipe is bonded to an outer surface of the air discharge pipe.

4. The hydrogen purge unit of a fuel cell system of claim 2, wherein:
the downstream section of the purge pipe is bonded to an outer top surface of the air discharge pipe.

5. The hydrogen purge unit of a fuel cell system of claim 1, wherein:
an end of the purge pipe is closed.

6. The hydrogen purge unit of a fuel cell system of claim 1, wherein:
the purge branch apertures formed in the purge pipe are separated from each other by a distance in a flow direction of the purge gas.

7. The hydrogen purge unit of a fuel cell system of claim 1, wherein:
the purge branch apertures formed in the purge pipe are separated from each other at a variable distance in a flow direction of the purge gas.

8. The hydrogen purge unit of a fuel cell system of claim 1, wherein:
the purge branch apertures formed are separated from each other in a flow direction of the purge gas so that distances between the purge branch apertures are gradually decreased as the purge branch apertures are positioned closer to an end of the purge pipe from an inlet end thereof.

9. A hydrogen purge unit of a fuel cell system comprising:
a purge pipe that connects an air discharge pipe that connects a fuel cell stack and a humidifying device and a hydrogen discharge pipe that receives hydrogen that is discharged from the fuel cell stack; and
a purge valve provided within the purge pipe,
wherein a downstream section of the purge pipe extending downstream from the purge valve is positioned within the air discharge pipe, and a plurality of purge branch apertures that discharge a purge gas discharged from the fuel cell stack into the air discharge pipe are each individually formed along a surface of the purge pipe.

10. The hydrogen purge unit of a fuel cell system of claim 9, wherein:
the air discharge pipe and the purge pipe are configured to have a double pipe structure.

11. The hydrogen purge unit of a fuel cell system of claim 9, wherein:
the downstream section of the purge pipe that extends from the purge valve serves as a flow path for the purge gas in the same direction as a flow direction of air in the air discharge pipe.

12. The hydrogen purge unit of a fuel cell system of claim 9, wherein:
the downstream section of the purge pipe extending from the purge valve is disposed on an upper inner surface of the air discharge pipe within the air discharge pipe.

13. The hydrogen purge unit of a fuel cell system of claim 12, wherein:
the downstream section of the purge pipe extending from the purge valve is bonded to an inner surface of the air discharge pipe.

14. The hydrogen purge unit of a fuel cell system of claim 12, wherein:
an end of the purge pipe is an outlet for the purge gas flowing in the purge pipe and is structured to release the purge gas into the inside of the air discharge pipe.

15. The hydrogen purge unit of a fuel cell system of claim 12, wherein:
the purge branch apertures are formed in along a bottom surface the purge pipe.

16. The hydrogen purge unit of a fuel cell system of claim 12, wherein:
the purge branch apertures are separately formed in the purge pipe and are space a distance apart in along the bottom surface of the purge pipe.

17. The hydrogen purge unit of a fuel cell system of claim 12, wherein:
the purge branch apertures are separately formed in the purge pipe to be separated from each other with a variable distance in a flow direction of the purge gas.

18. The hydrogen purge unit of a fuel cell system of claim 12, wherein:
an end of the purge pipe is an outlet for the purge gas in the purge pipe and is connected to an inside surface of the air discharge pipe, and
the purge branch apertures are separately formed along a bottom surface of the purge pipe in a flow direction of the purge gas so that distances between the purge branch apertures gradually increase as the purge branch apertures near an inlet end of the purge pipe from an outlet end thereof.
